(19) United States
(12) Patent Application Publication
(10) Pub. No.: US 2014/0202415 A1
(43) Pub. Date: Jul. 24, 2014

(54) SOLENOID SWITCH AND VEHICLE STARTER

(71) Applicants: Robert Bosch GmbH, Stuttgart (DE); Bosch Automotive Products (Changsha) Co., Ltd., Changsha (CN)

(72) Inventors: William Wang, Changsha (CN); Jiang Zhao, Changsha (CN); Guojun Chen, Changsha (CN)

(73) Assignees: Robert Bosch GmbH, Stuttgart (DE); Bosch Automotive Products (Changsha) Co., Ltd., Changsha (CN)

(21) Appl. No.: 14/162,195

(22) Filed: Jan. 23, 2014

(30) Foreign Application Priority Data
Jan. 23, 2013 (CN) 201310025224.3

(51) Int. Cl. H01H 50/02; F02N 11/08

(52) U.S. Cl. CPC H01H 50/02; F02N 11/087
USPC 123/179.25; 335/202

(57) ABSTRACT

A solenoid switch for a vehicle starter includes a housing defining an axial direction and a circumferential direction, a cap carrying a pair of contact studs, a solenoid core mounted in the housing in front of the cap, and an elastic element clamped between the front end of the cap and the solenoid core. The housing defines first retention portions at first circumferential with the first retention portions being separated from each other in the circumferential direction. The front end of the cap is fixedly clamped at the first circumferential locations between the first retention portions and a flange which is formed by radially inwardly crimping a back end of the housing. The front end of the cap is pushed against the flange by the elastic element at second circumferential locations each defined between two neighboring first circumferential locations. A vehicle starter includes the solenoid switch.

### TECHNICAL FIELD

The invention relates to a solenoid switch used in a vehicle starter and a vehicle starter comprising such a solenoid switch.

### BACKGROUND ART

A starter of a motor vehicle generally comprises an electric motor, a transmission mechanism, a control mechanism and the like. In the starting procedure of the vehicle engine, the electric motor generates a rotational torque which is transmitted to a gear ring on a flywheel of the engine via a driving gear of the transmission mechanism to drive a crank shaft of the engine to rotate.

The control mechanism controls the ON/OFF state of a main circuit of the starter, and controls the engagement and disengagement between the driving gear and the gear ring. Nowadays, a solenoid switch is generally used as the control mechanism of the starter. FIG. 1 is a schematic view of the structure of a current solenoid switch of the starter. The solenoid switch mainly comprises a solenoid core 4 and a winding assembly 6, both fixedly mounted in a housing 2, two contact studs 10 carried by a cap 8 which is fixed to the housing 2, a solenoid armature 16 axially movable in the inner side of the winding assembly 6, a switching shaft 12 carried by the solenoid core 4 and the solenoid armature 16 in a manner of being axially movable relative to them, an actuating bar 18 fixed to the solenoid armature 16, a striking bar 20 fixed in the solenoid armature 16, a contacting bridge 14 mounted to a back end of the switching shaft 12, etc. The actuating bar 18 is movably connected at its front end with a pinion engaging lever (not shown).

A back end of the solenoid core 4 and a front end of the cap 8 are clamped between a step 22 formed in a back portion of the housing 2 and a crimped inward flange 24 formed by the back end of the housing 2, facing towards each other. A disk spring 21 is disposed between the solenoid core 4 and the cap 8, the disk spring 21 being compressed in the axial direction to a full extent, without any ability of further axial deformation.

When a driver starts the vehicle by an ignition key, an electro-magnetic force is generated in the solenoid armature 16 by the winding assembly 6, under which force the solenoid armature 16 moves backwards towards the solenoid core 4. When the striking bar 20 comes into contact with the switching shaft 12, the striking bar 20 pushes the switching shaft 12 to move axially backwards together with it. The contacting bridge 14 is moved together with the switching shaft 12 until it comes into contact with the two contact studs 10 to electrically connects them, thereby a main circuit of the electric motor is switched on to drive the electric motor to rotate. After the contacting bridge 14 comes into contact with the two contact studs 10 and thus establishes electric connection between the two contact studs 10, the solenoid armature 16 continues to move by a distance towards the solenoid core 4, until it strikes the solenoid core 4 and is stopped by it. During this stage, the front end of the actuating bar 18 pushes the transmission mechanism via the pinion engaging lever, so that the driving gear moves forwards to be engaged with the gear ring on the flywheel of the engine, thereby the engine is started.

In the vehicle starting period, when the solenoid armature 16 strikes the solenoid core 4, an axial striking force thus generated is transmitted from the solenoid core 4 to the crimped portion 24 via the disk spring 21 and the cap 8. The crimped portion 24 may be elastically deformed backwardly and radially outwardly since the thickness of it is relatively small. In this condition, the cap 8 will quickly bounce backwards by a very small distance. Then, as the striking force disappears, the cap 8 gradually comes back to its original position in a vibrated manner. In the short period of the backward bouncing of the cap 8, the contact studs 10 carried by it also bounce backwards quickly, but the contacting bridge 14 cannot completely follow the backward bouncing action of the contact studs 10. Thus, the contacting bridge 14 and the contact studs 10 may be out of contact, which will result in instantaneous break of the main circuit of the electric motor. Such an instantaneous break may cause an instantaneous deep drop of the electric current in the main circuit of the electric motor, which may affect the operation of the electric motor. Meanwhile, an electric arc will be created between the contacting bridge 14 and the contact studs 10. It is known from test that the maximum power of this electric arc may be up to 30 kW, and the heat thus generated may be up to 8 Joule. This energy may result in burning and adhesion between the contacting bridge 14 and the contact studs 10.

### SUMMARY OF THE INVENTION

An object of the invention is to solve the problems found in the solenoid switch of the vehicle starter of prior art related with cap bouncing caused by the above mentioned striking as well as thus resulted burning and adhesion between the contacting bridge and the contact studs.

For this end, according to an aspect of the invention, there provides a solenoid switch used in a vehicle starter, which comprises a housing defining an axial direction and a circumferential direction; a cap carrying a pair of contact studs, the cap having a front end fixed in the housing; a solenoid core mounted in the housing in front of the cap; and an elastic element clamped between the front end of the cap and the solenoid core; wherein the housing defines a group of first retention portions at a plurality of first circumferential locations, the first retention portions being separated from each other in the circumferential direction; wherein the front end of the cap is fixedly clamped at the plurality of first circumferential locations between the group of first retention portions and a flange which is formed by radially inwardly crimping a back end of the housing; and wherein the front end of the cap is pushed against the flange by the elastic element at a plurality of second circumferential locations, each second circumferential location being defined between two neighboring first circumferential locations.

According to a preferred embodiment of the invention, a group of second retention portions, which are separated with each other in the circumferential direction, are defined in the housing at the plurality of second circumferential locations, the solenoid core being pushed against the group of second retention portions by the elastic element.

According to a preferred embodiment of the invention, the group of first retention portions are uniformly arranged along the circumferential direction and are located in a first plane which is perpendicular to the central axis of the housing, and the group of second retention portions are also uniformly arranged along the circumferential direction and are located in a second plane which is perpendicular to the central axis of the housing, the second plane being at an axial position forward of the first plane.

According to a preferred embodiment of the invention, a slot is defined by each second retention portion and two neighboring first retention portions; and the outer periphery of the solenoid core is formed with a group of arc shaped protrusions which are protruded radially outwardly, each arc shaped protrusion being located in a corresponding slot and being pushed against a corresponding second retention portion in the axially forward direction by the elastic element.

According to a preferred embodiment of the invention, the elastic element comprises an inner ring and a group of arc segments protruded radially outwardly from the inner ring, each arc segment being axially elastically compressed in a corresponding slot by an axially elastic compression amount which is smaller than the extreme axial compression amount of the elastic element.

According to a preferred embodiment of the invention, as an alternative to the solution of keeping the solenoid core by the second retention portions, the solenoid switch further comprises a winding assembly, the solenoid core being pushed against the winding assembly in the axially forward direction by the elastic element.

According to a preferred embodiment of the invention, the solenoid switch further comprises a disk spring, the disk spring being axially compressed to a full extent between the cap and the group of first retention portions at the plurality of first circumferential locations, and being located between the cap and the elastic element at the plurality of second circumferential locations.

According to a preferred embodiment of the invention, a locating protrusion is formed on a front surface of the front end of the cap in the form of a circular ring protruded forwardly in the axial direction, for keeping the position of the elastic element.

According to a preferred embodiment of the invention, the elastic element is selected from a group consisted of: a waved spring ring, a disk spring, a coil spring, a composite spring, and a rubber spring.

The invention in another aspect provides a vehicle starter which comprises an electric motor; a transmission mechanism coupled with an output shaft of the electric motor; and a solenoid switch described above for controlling the operations of the electric motor and the transmission mechanism.

According to the solenoid switch of the invention, when the solenoid core is subjected to the axial strike of the solenoid armature, the striking force is damped or absorbed by means of the axial elastic deformation ability of the elastic element. Thus, when the solenoid armature strikes the solenoid core, the cap does not noticeably bounce in the axial direction, so that the contacting bridge and the contact studs are not disengaged from each other and the main circuit of the electric motor will not instantaneously break. As a result, the problems found in prior art, including instantaneous deep drop of the electric current in the main circuit of the electric motor and burning and adhesion between the contacting bridge and the contact studs, can be avoided.

### BRIEF DESCRIPTION OF THE DRAWINGS

FIG. 1 is a sectional view of a solenoid switch in a vehicle starter according to prior art:

FIG. 2 is a schematic view of a cap clamping structure in a back end portion of a housing of the solenoid switch according to prior art;

FIGS. 3-5 are schematic views of cap clamping structures that can be used in a back end portion of a housing of a solenoid switch according to the invention;

FIG. 6 is a schematic view of a solenoid switch in a vehicle starter according to a preferred embodiment of the invention;

FIGS. 7 and 8 are front and back perspective view of a solenoid core that can be used in the solenoid switch shown in FIG. 6;

FIG. 9 is a schematic view of a housing of the solenoid switch shown in FIG. 6;

FIG. 10 is a schematic view of an elastic element that can be used in the solenoid switch shown in FIG. 6:

FIG. 11 is a schematic view of a disk spring that can be used in the solenoid switch shown in FIG. 6; and

FIG. 12 is a schematic view of another elastic element that can be used in the solenoid switch shown in FIG. 6.

### DETAILED DESCRIPTION OF PREFERRED EMBODIMENTS

Some preferred embodiments of the invention will be described now with reference to the drawings.

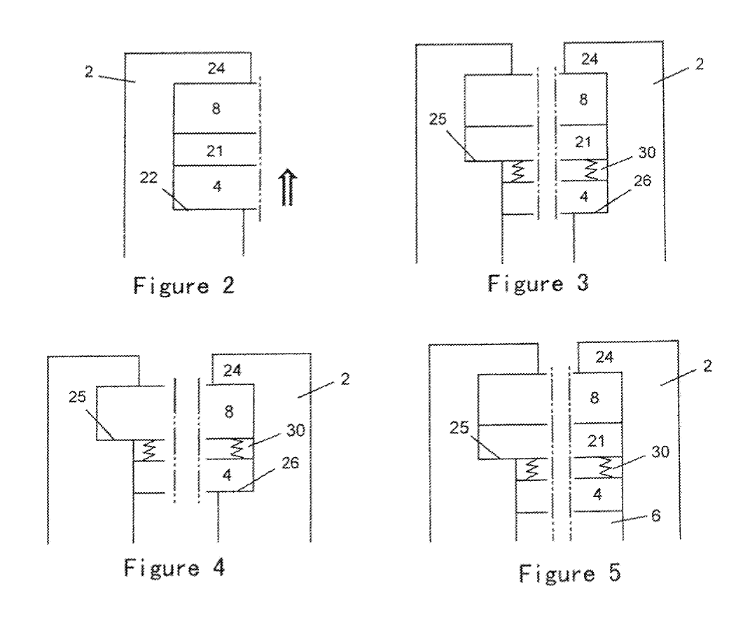

First, differences between the invention and prior art will be described with reference to the schematic views shown in FIGS. 2-5. It is noted that, for describing the solenoid switch of the invention, the term “front” or “forward” used here refers to the side proximal to the vehicle engine in the axial direction, and “back” or “backward” refers to the side distal from the vehicle engine in the axial direction.

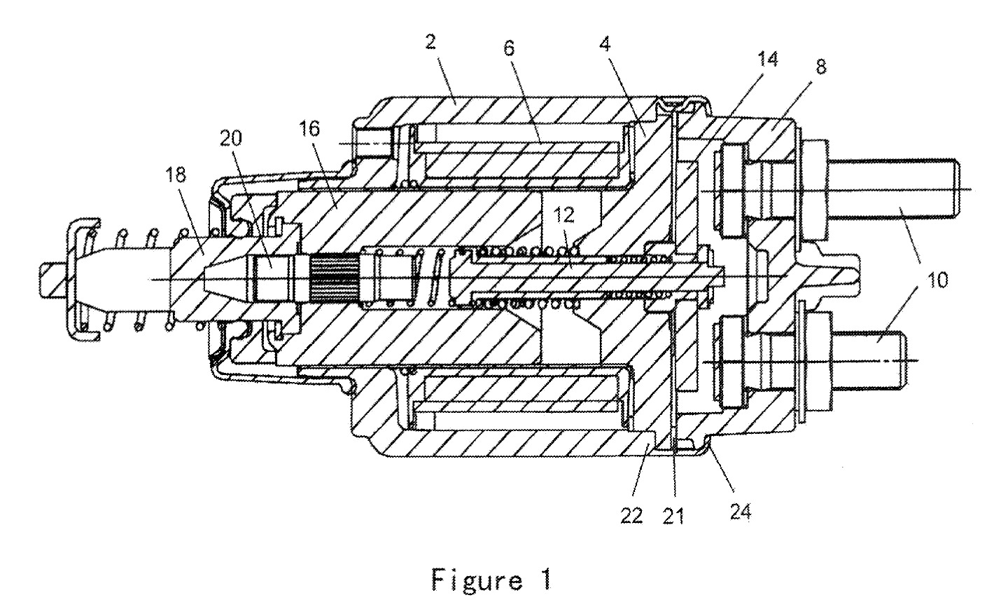

FIG. 2 schematically shows the cap clamping structure in the back end portion of the housing 2 of the solenoid switch according to prior art as shown in FIG. 1, wherein the cap 8, the disk spring 21 and the solenoid core 4 are clamped between the step 22 of the housing 2 and the crimped inward flange 24 with a certain preloaded axial force, the disk spring 21 is compressed in the axial direction to a full extent between the cap 8 and the solenoid core 4 and has no further axial deformation ability, and thus no axial shock absorption function is provided. When the solenoid core 4 is subjected to an axial strike from the solenoid armature 16, the striking force is transmitted to the crimped inward flange 24 through the disk spring 21 and the cap 8 without damping, which results in large axial deformation of the crimped inward flange 24. The axial deformation is accompanied by axial bouncing of the cap, which will cause the related problems as discussed in the Background Art part.

The invention suppresses or eliminates the axial bouncing of the cap by changing the clamping manner of the cap. FIGS. 3 to 5 schematically show some feasible embodiments of the cap clamping structure according to the invention.

In the embodiment shown in FIG. 3, the outer peripheries of the cap 8 and the disk spring 21 are fixedly clamped at a plurality of first circumferential locations (each being represented by the left part in FIG. 3) between a corresponding group of circumferentially separated first retention portions 25 of the housing 2 and the crimped inward flange 24. Further, the outer peripheries of the cap 8, the disk spring 21 and the solenoid core 4 are elastically clamped by means of an elastic element 30 (which is disposed between the disk spring 21 and the solenoid core 4) at a plurality of second circumferential locations (each being represented by the right part in FIG. 3) between a corresponding group of circumferentially separated second retention portions 26 of the housing 2 and the crimped inward flange 24.

The solenoid core 4 is supported at its front side by the second retention portions 26, and is supported at its back side by the elastic element 30. When the solenoid core 4 is subjected to an axial strike from the solenoid armature, it tends to move axially backwards against the action force of the elastic element 30. The axially backwardly directed striking force applied to the solenoid core 4 is weakened and delayed first under the damping effect of the elastic element 30, and is then transmitted to the cap 8 through the disk spring 21. The weakened and delayed striking force will not cause backward bouncing of the cap 8. Thus, the problems found in prior art, including instantaneous deep drop of the electric current in the main circuit of the electric motor and burning and adhesion between the contacting bridge and the contact studs, can be avoided.

It is appreciated that, according to some embodiments of the invention, the disk spring 21 can be omitted. For example, in the embodiment shown in FIG. 4, the outer periphery of the cap 8 is fixedly clamped at a plurality of first circumferential locations (each being represented by the left part in FIG. 4) between a corresponding group of circumferentially separated first retention portions 25 of the housing 2 and the crimped inward flange 24. Further, the outer peripheries of the cap 8 and the solenoid core 4 are elastically clamped by means of an elastic element 30 (which is disposed between the cap 8 and the solenoid core 4) at a plurality of second circumferential locations (each being represented by the right part in FIG. 4) between a corresponding group of circumferentially separated second retention portions 26 of the housing 2 and the crimped inward flange 24. Except that the disk spring is omitted, other aspects of the embodiment shown in FIG. 4 are similar to that of the embodiment shown in FIG. 3, and similar striking force weakening and delaying effects can be obtained. It is noted that, since there is no disk spring, the vibration damping ability of the embodiment shown in FIG. 4 is not as good as the embodiment shown in FIG. 3.

FIG. 5 shows a cap clamping structure according to another embodiment, which is a variant of the embodiment shown in FIG. 3, wherein the second retention portions 26 are omitted, and the solenoid core 4 is supported at its front side by the winding assembly 6, as will be described. In this way, the strike of the solenoid armature to the solenoid core 4 can be absorbed at least partly by the elastic element 30, so that the striking force is effectively weakened and delayed before transmitted to the cap 8. Other aspects of the embodiment shown in FIG. 5 are similar to that of the embodiment shown in FIG. 3, and similar striking force weakening and delaying effects can be obtained. It is noted that, for the embodiment shown in FIG. 4, the second retention portions 26 may also be omitted, and in this case, the solenoid core 4 is supported by the winding assembly 6.

Some solenoid switches of vehicle starters using the above cap clamping structures of the invention will be described now,

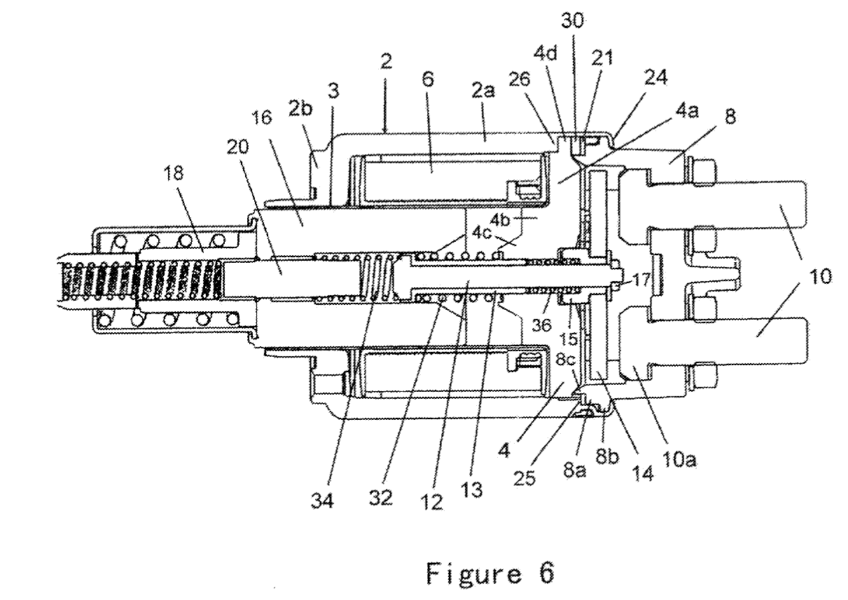

FIG. 6 shows schematically a solenoid switch according to an embodiment of the invention, in which the cap clamping structure shown in FIG. 3 is used.

As shown in FIG. 6, the solenoid switch comprises a housing 2 which has a main body 2a having a substantially cylindrical shape and a front end wall 2b provided on a front end (left end in FIG. 6, the end facing towards the vehicle engine) of the main body, the front end wall being formed with a central axial through hole therethrough.

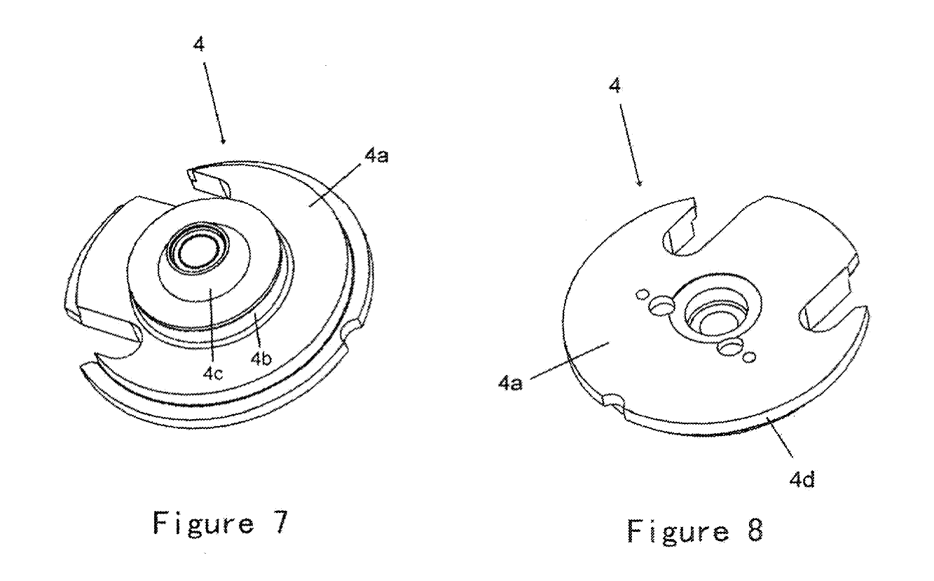

In a back portion of the main body 2a of the housing 2, a solenoid core 4 is fixedly mounted. As shown in FIGS. 6-8, the solenoid core 4 comprises a substantially disk shaped larger-diameter portion 4a, a substantially cylindrical smaller-diameter portion 4h protruding forwards from the larger-diameter portion, and a substantially frusto-conical portion 4c protruded forwards from the smaller-diameter portion 4b. A group of arc shaped protrusions 4d are formed to be protrude radially outwardly on the outer periphery of the larger-diameter portion 4a. These arc shaped protrusions 4d are uniformly distributed along the same circumference (not exactly shown in FIGS. 7 and 8) and each extend through an angle along the circumferential direction. Further, a guiding hole is formed in the axial direction through the solenoid core 4 from its front end to its back end.

A substantially cylindrical sleeve 3 of a non-magnetic material (for example, brass) is mounted in the housing 2, wherein the sleeve 3 has a front end inserted in the front end wall 2b of the housing 2, and a back end mounted around the smaller-diameter portion 4b of the solenoid core 4, and the sleeve 3 is thus fixed in the housing 2. A winding assembly 6 is mounted in a space between the sleeve 3 and the main body of the housing 2, and is supported by the sleeve 3.

A solenoid armature 16 is disposed in a substantially front portion of the sleeve 3 in an axially movable manner. The solenoid armature 16 has substantially a cylinder shape.

An actuating bar 18 is fixed to a front end of the solenoid armature 16. The actuating bar extends forwards from its back end which is connected with the front end of the solenoid armature 16, and is operatively coupled at its front end with an upper end of a pinion engaging lever (not shown). The pinion engaging lever is pivotably supported at its substantially middle portion, and is coupled at its lower end with a transmission mechanism. Thus, when the actuating bar 18 moves axially backwards (to the right in FIG. 6), it drives the transmission mechanism to move axially forwards via the pinion engaging lever, so that a driving gear of the transmission mechanism moves towards a gear ring on a flywheel of the engine to come into engagement with it. On the other hand, when the actuating bar 18 moves axially forwards (to the left in FIG. 6), it drives the transmission mechanism to move axially backwards via the pinion engaging lever, so that the driving gear of the transmission mechanism is disengaged from the gear ring on the flywheel of the engine.

A striking bar 20 is fixedly disposed inside the solenoid armature 16. A front portion of the striking bar 20 may be inserted into a back portion of the actuating bar 18 to help the locating and fixing of the actuating bar 18 relative to the solenoid armature 16. A middle portion of the striking bar 20 is fixed to a corresponding portion of the solenoid armature 16. A back portion of the striking bar 20 extends into an axial accommodating bore formed in the solenoid armature 16.

A switching shaft 12 is disposed in the accommodating bore of the solenoid armature 16 and the guiding hole of the solenoid core 4, the switching shaft 12 being axially movable relative to the solenoid armature 16 and the solenoid core 4. A guiding sleeve 13 is carried on the outer periphery of the switching shaft 12, for guiding the switching shaft 12 in the solenoid armature 16 and the solenoid core 4, as well as for increasing the gap between the inner periphery wall defining the guiding hole of the solenoid core 4 and the outer circumference of the switching shaft 12, so that the magnetic gap between the solenoid core 4 and the switching shaft 12 is increased to reduce the interference of the switching shaft 12 to the magnetic circuit generated by the winding assembly 6.

A first return spring 32 is arranged between a front end of the switching shaft 12 and a front end of the solenoid core 4 (the substantially frusto-conical portion 4c) for applying a forwardly directed force to the switching shaft 12. so that the switching shaft 12 is kept in its original position, a most forward position, when the solenoid switch is in its rest state.

A second return spring 34 is arranged in the accommodating bore between the bottom of the accommodating bore and the front end of the switching shaft 12 for applying a forwardly directed force to the solenoid armature 16, so that the solenoid armature 16 is kept in its original position, a most forward position, when the solenoid switch is in its rest state.

A front portion of the switching shaft 12 is disposed in the accommodating bore of the solenoid armature 16, a middle portion of the switching shaft 12 extends through the guiding hole of the solenoid core 4, and a back end of the switching shaft 12 is exposed from a back end surface of the solenoid core 4.

A contacting bridge 14 is mounted to the back end of the switching shaft 12. In more details, a mount 15 is axially slidably mounted around the back portion of the switching shaft 12, and the contacting bridge 14 is carried by the mount 15.

Further, a third return spring 36 is arranged around the switching shaft 12 between a back end of the guiding sleeve 13 and the mount 15. The contacting bridge 14 which is carried by the mount 15 is movable (slidable) axially forwards on the switching shaft 12 against the pushing force of the third return spring 36, and is also movable backwards until it is stopped by a fastener 17 fixed to the back end of the switching shaft 12.

A cap 8, generally made of plastic, is fixed to a back portion of the housing 2, and two contact studs 10 extend through and are fixed to the cap 8. The two contact studs 10 each have an enlarged front end forming a contacting end 10a, front surfaces of the two contacting ends 10a facing towards a back surface of the contacting bridge 14. The contact studs 10 each have a front portion fixed in the cap 8 and a back portion exposed from a back surface of the cap 8 and forming a connecting terminal.

The cap 8 comprises a front end 8a adapted to be assembled in the housing 2, the outer periphery of the front end 8a being formed with a circular locating ridge 8b protruded radially outwardly. Further, a locating protrusion 8c is formed on a front surface of the front end 8a of the cap 8 in the form of a circular ring protruded forwardly in the axial direction. The circular-ring shaped the locating protrusion 8c may be either continuous or discrete in the circumferential direction.

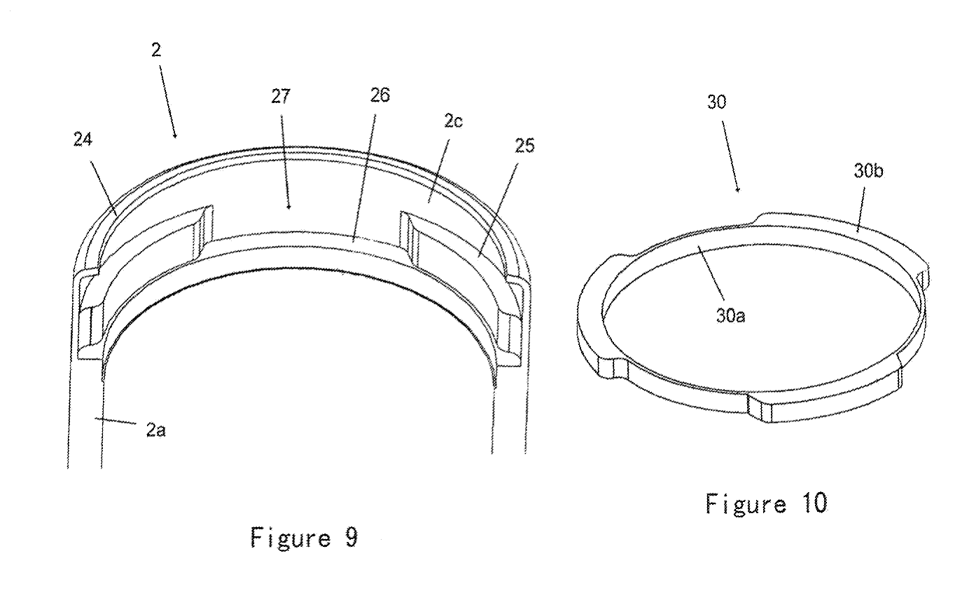

As shown in FIG. 6, a back end of the solenoid core 4 (the larger-diameter portion 4a) and the front end 8a of the cap 8 are clamped in the back end portion of the housing 2 by means of the cap clamping structure shown in FIG. 3. For this end, with reference to FIG. 9, a thinner portion 2c, which has a reduced thickness with respect to the main body 2a, is formed behind the substantially cylindrical main body 2a of the housing 2. Between the main body 2a and thinner portion 2c, there are formed with a group of (at least two, for example, three) first retention portions 25, which are faced to the backward side and are separately arranged in the circumferential direction, and a group of (at least two, for example, three) second retention portions 26, which are also faced to the backward side and are separately arranged in the circumferential direction, having the same number with the first retention portions 25. The group of first retention portions 25 are uniformly distributed in the circumferential direction and are all located in a first plane which is perpendicular to the central axis of the housing 2, and the group of second retention portions 26 are also uniformly distributed in the circumferential direction and are all located in a second plane which is perpendicular to the central axis of the housing 2, the first plane being at an axial position backward of the second plan. The first retention portions 25 are alternatingly disposed with the second retention portions 26 in the circumferential direction, a slot 27 is defined by each pair of neighboring first retention portions 25 and a corresponding second retention portion 26 therebetween, for accommodating a corresponding arc shaped protrusion 4d of the solenoid core 4. Thus, the number of the arc shaped protrusions 4d is equal to that of the slots 27, and each arc shaped protrusion is sized and shaped to be received in a corresponding slot 27.

Each of the first and the second retention portions may extend through an angle along the circumferential direction, for example, it may be in the form of an arc portion as illustrated (in this case, each of the first and the second retention portions forms a step surface facing toward the backward side). Alternatively, each retention portion may be not a continuous arc portion, for example, it may be in the form of a plurality of discrete segments.

The back end of thinner portion 2c is adapted to be formed into a crimped inward flange 24, in the form of a radially inwardly extended flange, after the solenoid core 4 and the cap 8 are assembled into the housing 2. Thus, it can be understood that, although the crimped inward flange 24 is already shown in FIG. 9, it is formed in the assembling procedure of the solenoid switch.

With reference to FIGS. 3 and 6, the front end 8a of the cap 8 and the back end of the solenoid core 4 (the larger-diameter portion 4a) are clamped in the back end of the housing 2 by the crimped inward flange 24, with the elastic element 30 and the disk spring 21 disposed therebetween, wherein the elastic element 30 is located at the back side of the solenoid core 4, the disk spring 21 is located at the back side of the elastic element 30, and the cap 8 is located at the back side of the disk spring 21.

The elastic element 30 and the disk spring 21 are disposed around the outer periphery of the circular locating protrusion 8c, so as to locate the elastic element 30 and the disk spring 21 relative to the cap 8.

The outer peripheries of the cap 8 and the disk spring 21 are fixedly clamped between the first retention portions 25 of the housing 2 and the crimped inward flange 24 at the plurality of first circumferential locations (wherein one of the first circumferential locations is shown in the lower part of FIG. 6). Further, the outer peripheries of the cap 8, the disk spring 21 and the solenoid core 4 are elastically clamped between the second retention portions 26 of the housing 2 and the crimped inward flange 24 at the plurality of second circumferential locations (wherein one of the second circumferential location is shown in the upper part of FIG. 6) by means of the elastic element 30.

The main body of the housing 2 has an enough thickness. Thus, although the cap 8 is fixedly supported in the axial direction by the group of circumferentially separated first retention portions 25 via the disk spring 2, the cap 8 is still kept with high strength in the housing 2.

The elastic element 30 may be in any suitable form, such as waved spring rings, disk springs, coil springs, composite springs, rubber springs, etc.

In the embodiment shown in FIG. 6, the elastic element 30 is in the form of a washer made of an elastic material, such as rubber, silicone, etc. With reference to FIG. 10, the washer forming the elastic element 30 comprises a complete turn of circular inner ring 30a and a group of arc segments 30b protruded radially outwardly from the inner ring 30a. The arc segments 30b are configured to be inserted into the slots 27 of the housing 2 respectively, and thus have the same number with the slots 27. The axial thickness of each washer, especially of its arc segments 30b, is larger than the axial depth of the slots 27 minus the axial thickness of the arc shaped protrusions 4d.

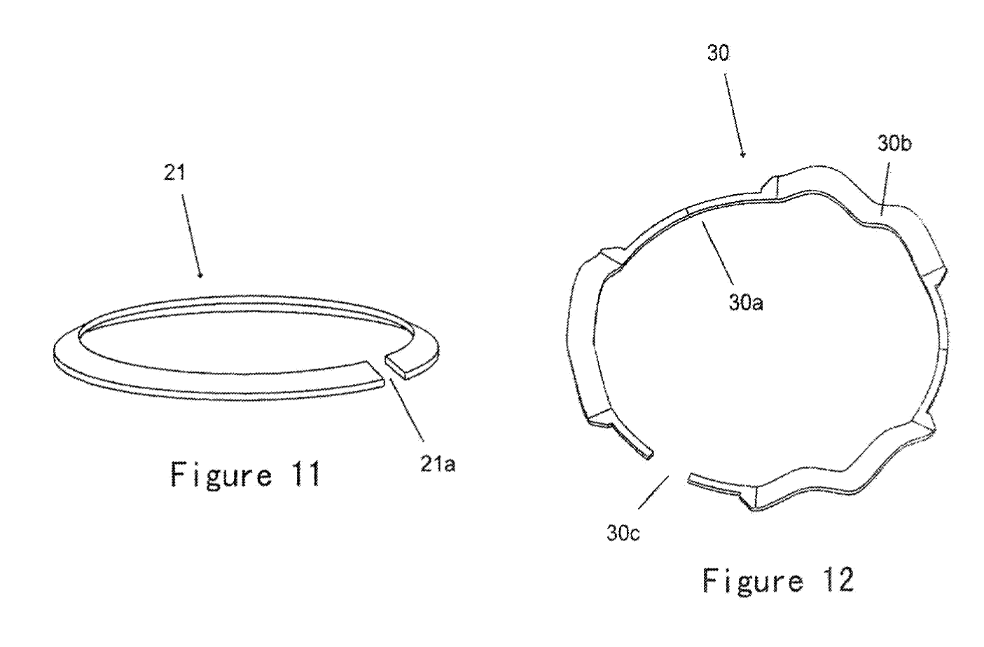

An embodiment of the disk spring 21 is shown in FIG. 11. The disk spring 21 has a notch 21a, so that the disk spring 21 is easier to be axial deformed by compression.

With reference to FIG. 6, when assembling the solenoid core 4 and the cap 8 to the housing 2, first, the solenoid core 4 is put into the housing 2 from the back end of the housing 2, with the frusto-conical portion 4c facing forwards, so that the arc shaped protrusions 4d of the solenoid core 4 are inserted into the slots 27 of the housing 2 respectively. Front surfaces of the arc shaped protrusions 4d abut against the second retention portions 26.

Then, the switching shaft 12 is inserted through the guiding hole in the solenoid core 4, and the contacting bridge 14 is mounted to the back end of the switching shaft 12 by means of the mount 15 and the fastener 17.

Then, the elastic element 30 is put into the housing 2 from the back end of the housing 2, so that the arc segments 30b are inserted into the slots 27 of the housing 2 respectively.

Then, the disk spring 21 is mounted to be surrounding the circular locating protrusion 8c of the cap 8, and the front end 8a of the cap 8 is put into the housing 2. Then, the cap 8 is pushed forwards by a certain axial force, so that the front surface of the front end 8a pushes the disk spring 21 and thus pushes the elastic element 30 in the axially forward direction, so that the elastic element 30 is deformed in the axial direction to a certain extent by compression, until the disk spring 21 is pushed tightly against the first retention portions 25 and is compressed in the axial direction to the full extent to become flat. Now the axial compression amount of the elastic element 30 is smaller than its maximum allowance compression amount, that is, the extreme axial compression amount of it is not reached yet, and thus it has further axial deformation ability. In this state, the back end of the thinner portion 2c of the housing 2 is crimped radially inwardly to form the crimped inward flange 24.

When all other components of the solenoid switch are assembled in or to the housing 2, the assembling of the solenoid switch shown in FIG. 6 is completed. Now, the protrusions 4d of the solenoid core 4 are supported at their front side by the group of second retention portions 26, and are supported at their back side by the elastic element 30. Thus, in normal state, the solenoid core 4 is pushed by the elastic element 30 against the second retention portions 26. When the solenoid core 4 is subjected to an axial strike from the solenoid armature 16, it tends to move axially backwards against the action force of the elastic element 30. Since the disk spring 21 and the solenoid core 4 are not in direct contact with each other as that in prior art, but are kept to be separated by the elastic element 30, the solenoid core 4 cannot strike the disk spring 21 directly. When the solenoid core 4 moves axially backwards, it is under the damping effect of the elastic element 30, so that the movement of the solenoid core 4, if any, will be damped down quickly, no long time oscillation will occur. On the other hand, the striking force of the solenoid core 4 is weakened and delayed by means of the elastic element 30, and is then transmitted to the cap 8 via the disk spring 21. Since the front end 8a of the cap 8 is firmly clamped between the crimped inward flange 24 and the first retention portions 25, the weakened and delayed striking force will not cause backward bouncing of the cap 8. As a result, the problems found in prior art, including instantaneous deep drop of the electric current in the main circuit of the electric motor, and burning and adhesion between the contacting bridge and the contact studs, can be avoided.

It is appreciated that, as alternatives, the cap clamping structure shown in FIG. 4 or FIG. 5 can also be used in the solenoid switch shown in FIG. 6.

As stated above, the elastic element 30 may also be in other forms, such as the waved spring ring shown in FIG. 12. The waved spring ring may be made of an elastic metal sheet, having a circular inner ring 30a and a group of arc segments 30b protruded radially outwardly from the inner ring 30a. The arc segments 30b are configured to be inserted into the slots 27 of the housing 2, and thus the number of them is equal to that of the slots 27.

Each arc segment 30b has waves in the axial direction in its profile, so that the waved spring ring 30 is axially elastically deformable. In addition, the waved spring ring comprises a notch 30c, so that it is easier to be axial deformed by compression.

The elastic element 30 in other suitable forms can also be conceived.

It is confirmed by imitation and test that, according to the solenoid switch of prior art, when the solenoid armature strikes the solenoid core, the cap undergoes dramatic axial bouncing, which may results in disengagement between the contacting bridge and the contact studs. The disengagement in turn may cause instantaneous break of the main circuit of the electric motor. The electric current in the main circuit of the electric motor drops deeply instantaneously when such an instantaneous circuit break occurs, which may affect the operation of the electric motor. In addition, electric arc may be generated between the contacting bridge and the contact studs, which may result in burning and adhesion between the contacting bridge and the contact studs.

On the contrary, according to the invention, when the solenoid armature strikes the solenoid core, due to the damping effect of the elastic element which is not compressed in the axial direction to a full extent, the cap does not undergoes noticeable bouncing, and thus the contacting bridge and the contact studs are not disengaged from each other, and no instantaneous break occurs in the main circuit of the electric motor. As a result, the problems found in prior art, including instantaneous deep drop of the electric current in the main circuit of the electric motor, and burning and adhesion between the contacting bridge and the contact studs, can be avoided.

The invention in another aspect relates to a solenoid switch having a structure described above and a vehicle starter comprising such a solenoid switch.

While certain embodiments of the invention have been described here, they are presented by way of explanation only and are not intended to limit the scope of the invention. Various modifications, substitutions and changes can be made by those skilled in the art within the scope and spirit of the invention as defined in the attached claims and their equivalents.

1. A solenoid switch for a vehicle starter, comprising:
a housing defining an axial direction and a circumferential direction;
a cap carrying a pair of contact studs, the cap having a front end fixed in the housing;
a solenoid core mounted in the housing in front of the cap; and
an elastic element clamped between the front end of the cap and the solenoid core;
wherein the housing defines a group of first retention portions at a plurality of first circumferential locations, the first retention portions being separated from each other in the circumferential direction;
wherein the front end of the cap is fixedly clamped at the plurality of first circumferential locations between the group of first retention portions and a flange which is formed by radially inwardly crimping a back end of the housing; and
wherein the front end of the cap is pushed against the flange by the elastic element at a plurality of second circumferential locations, each second circumferential location being defined between two neighboring first circumferential locations.

2. The solenoid switch of claim 1, wherein a group of second retention portions, which are separated with each other in the circumferential direction, are defined in the housing at the plurality of second circumferential locations, the solenoid core being pushed against the group of second retention portions by the elastic element.

3. The solenoid switch of claim 2, wherein the group of first retention portions are uniformly arranged along the circumferential direction and are located in a first plane which is perpendicular to the central axis of the housing, and the group of second retention portions are also uniformly arranged along the circumferential direction and are located in a second plane which is perpendicular to the central axis of the housing, the second plane being at an axial position forward of the first plane.

4. The solenoid switch of claim 3, wherein a slot is defined by each second retention portion and two neighboring first retention portions; and
the outer periphery of the solenoid core is formed with a group of arc shaped protrusions which are protruded radially outwardly, each arc shaped protrusion being located in a corresponding slot and being pushed against a corresponding second retention portion in the axially forward direction by the elastic element.

5. The solenoid switch of claim 4, wherein the elastic element comprises an inner ring and a group of arc segments protruded radially outwardly from the inner ring, each arc segment being axially elastically compressed in a corresponding slot by an axially elastic compression amount which is smaller than the extreme axial compression amount of the elastic element.

6. The solenoid switch of claim 1, further comprising a winding assembly, the solenoid core being pushed against the winding assembly in the axially forward direction by the elastic element.

7. The solenoid switch of claim 1, further comprising a disk spring, the disk spring being axially compressed to a full extent between the cap and the group of first retention portions at the plurality of first circumferential locations, and being located between the cap and the elastic element at the plurality of second circumferential locations.

8. The solenoid switch of claim 1, wherein a locating protrusion is formed on a front surface of the front end of the cap in the form of a circular ring protruded forwardly in the axial direction, the locating protrusion being configured to keep the position of the elastic element.

9. The solenoid switch of claim 1, wherein the elastic element is selected from a group consisted of: a waved spring ring, a disk spring, a coil spring, a composite spring, and a rubber spring.

10. A vehicle starter, comprising:
an electric motor;
a transmission coupled with an output shaft of the electric motor; and
a solenoid switch configured to control the operations of the electric motor and the transmission, the solenoid switch including:
a housing defining an axial direction and a circumferential direction;
a cap carrying a pair of contact studs, the cap having a front end fixed in the housing;
a solenoid core mounted in the housing in front of the cap; and
an elastic element clamped between the front end of the cap and the solenoid core;
wherein the housing defines a group of first retention portions at a plurality of first circumferential locations, the first retention portions being separated from each other in the circumferential direction;
wherein the front end of the cap is fixedly clamped at the plurality of first circumferential locations between the group of first retention portions and a flange which is formed by radially inwardly crimping a back end of the housing; and
wherein the front end of the cap is pushed against the flange by the elastic element at a plurality of second circumferential locations, each second circumferential location being defined between two neighboring first circumferential locations.
